(19) United States
(12) Patent Application Publication
(10) Pub. No.: US 2018/0066396 A1
(43) Pub. Date: Mar. 8, 2018

(54) SURFACING FABRICS, COMPOSITES COMPRISING THE SAME, AND COMPOSITIONS AND METHODS FOR PREPARING THE SAME

(71) Applicant: Precision Fabrics Group, Inc., Greensboro, NC (US)

(72) Inventors: Brandon Ratcliffe, Greensboro, NC (US); Richard Bliton, Greensboro, NC (US); Nelson Douglass, Garner, NC (US); William Carroll, Knoxville, TN (US); William Oscar Phillips, Greensboro, NC (US)

(21) Appl. No.: 15/687,133

(22) Filed: Aug. 25, 2017

Related U.S. Application Data
(60) Provisional application No. 62/383,035, filed on Sep. 2, 2016.

(51) Int. Cl. D06M 23/00; B32B 5/02; B32B 27/12; B32B 27/18; B29C 70/52; C08J 5/24; C08K 3/00

(52) U.S. Cl. CPC D06M 23/005; B32B 5/022; B32B 5/024; B32B 27/12; C08J 2400/26; B29C 70/52; C08J 5/24; C08K 3/0033; B32B 2255/26; B32B 27/18

(57) ABSTRACT

Provided herein are surfacing fabrics, such as, for example, those used as veils for a fiber reinforced polymer material, and to composites comprising a surfacing fabric of the present invention. Also provided are compositions and methods for preparing surfacing fabrics and composites of the present invention.

This application claims the benefit of U.S. Provisional Patent Application Ser. No. 62/383,035, filed Sep. 2, 2016, the disclosure of which is incorporated herein by reference in its entirety.

### FIELD

The present invention generally relates to surfacing fabrics, such as, for example, those used as veils for a fiber reinforced polymer material, and to composites comprising a surfacing fabric of the present invention. The present invention also relates to compositions and methods for preparing surfacing fabrics and composites of the present invention.

### BACKGROUND

Fiber reinforced composite materials are frequently used outdoors and are exposed to environmental elements, such as UV radiation, which can negatively impact appearance and/or performance of the fiber reinforced composite materials. To improve the appearance and/or performance of fiber reinforced composite materials, attempts have been made to improve the surface properties of the fiber reinforced composite materials. Some attempts to improve surface properties of fiber reinforced composite materials have involved adding functional resins/chemicals to the entire composite. Another approach to solve these problems has been to paint or apply a coating after the composite fabrication process. However, this may create an additional expense and variability of another production step and may create additional waste material.

### SUMMARY OF EXAMPLE EMBODIMENTS

Aspects of the present invention include surfacing fabrics and composites along with compositions and methods for preparing the same.

A first aspect of the present invention is a surfacing fabric including a fabric comprising at least one surface coated with a partially cured resin.

A second aspect of the present invention is a composite including a surfacing fabric comprising at least one surface coated with a first resin; a reinforcing material; and a second resin, wherein the second resin binds the surfacing fabric to the reinforcing material. The second resin may be different than the first resin.

Another aspect of the present invention is a composite as described herein comprising a fabric and/or film on a surface of the composite and/or surfacing fabric. The fabric and/or film may enable and/or improve processing of the composite such as, e.g., in a pultrusion process, by acting as a release layer and/or preventing adhesion of the surfacing fabric to manufacturing equipment (e.g., pultrusion die). The fabric and/or film may be part of the composite or may be stripped and/or removed from the composite after the composite is formed.

Another aspect of the present invention is a composition including a resin in an amount of about 50% to about 99% by weight of the composition; an initiator or a curing agent in an amount of about 0.1% to about 5% by weight of the composition; and a mold release agent in an amount of 0.01% to about 5% by weight of the composition. A performance enhancing agent may be present in the composition in an amount of about 0% to about 20% by weight of the composition.

A further aspect of the present invention is a method of preparing a surfacing fabric including contacting at least one surface of a fabric with a resin; and partially curing the resin, thereby preparing the surfacing fabric.

Another aspect of the present invention is a method of preparing a composite including placing a composite resin between a reinforcing material and a surfacing fabric comprising a surfacing resin; and curing the composite resin, thereby preparing the composite.

The foregoing and other aspects of the present invention will now be described in more detail including other embodiments described herein.

### BRIEF DESCRIPTION OF THE DRAWINGS

FIG. 1A is a schematic of an example composite according to some embodiments of the present invention.

FIG. 1B is a schematic of an example composite including a fabric and/or film according to some embodiments of the present invention.

FIG. 1C is a schematic of an example composite including an anti-migration layer according to some embodiments of the present invention.

FIG. 1D is a schematic of an example composite including an anti-migration layer and a fabric and/or film according to some embodiments of the present invention.

FIG. 2 is a schematic of another example composite according to some embodiments of the present invention.

FIG. 3A is an illustration of an example method of manufacturing a composite of the present invention using a pultrusion process according to some embodiments of the present invention.

FIG. 3B is an illustration of an example method of manufacturing a composite of the present invention that includes a fabric and/or film on the surface according to some embodiments of the present invention.

FIG. 3C is an illustration of an example method of manufacturing a composite of the present invention that includes an anti-migration layer according to some embodiments of the present invention.

FIG. 3D is an illustration of an example method of manufacturing a composite of the present invention that includes an anti-migration layer and a fabric and/or film according to some embodiments of the present invention.

FIG. 3E is an illustration of an example method of manufacturing a composite of the present invention according to some embodiments of the present invention.

FIG. 4A is an illustration of another example method of manufacturing a composite of the present invention using a pultrusion process according to some embodiments of the present invention.

FIG. 4B is an illustration of another example method of manufacturing a composite of the present invention that includes a fabric and/or film on the surface according to some embodiments of the present invention.

FIG. 4C is an illustration of an example method of manufacturing a composite of the present invention that includes an anti-migration layer according to some embodiments of the present invention.

FIG. 4D is an illustration of an example method of manufacturing a composite of the present invention that includes an anti-migration layer and a fabric and/or film according to some embodiments of the present invention.

FIG. 4E is an illustration of an example method of manufacturing a composite of the present invention according to some embodiments of the present invention.

FIG. 5 is an image of four different composites at 0 hours of UV exposure.

FIG. 6 is an image of the four different composites of FIG. 5 after 2,000 hours of UV exposure.

FIG. 7 is an image comparing the Traditional Veil composite at 0 hours and 2,000 hours of UV exposure to the Sample 32 composite at 0 hours and 2,000 hours of UV exposure.

FIG. 8 is an image comparing the Sample 37 composite at 0 hours and 1,000 hours of UV exposure to the Painted Sample composite at 0 hours and 1,000 hours of UIV exposure.

FIG. 9 is an image comparing the Sample 37 composite at 0 hours and 2,000 hours of UV exposure to the Painted Sample composite at 0 hours and 2,000 hours of UV exposure.

FIG. 10 is an image comparing the Sample 37 composite at 0 hours, 1,000 hours and 2,000 hours of UV exposure.

### DESCRIPTION OF EXAMPLE EMBODIMENTS

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

It will be understood that when an element or layer is referred to as being “on”, “attached to”, “connected to”, “coupled to”, “coupled with” or “contacting” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. It will be appreciated by those of skill in the art that a structure referred to as being “directly on,” “directly connected to, or “directly coupled to” another structure may partially or completely cover one or more surfaces of the other structure. It will also be appreciated by those of skill in the art that references to a structure or feature that is disposed “adjacent” another structure or feature may have portions that overlap or underlie the adjacent structure or feature.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

The term “about,” as used herein when referring to a measurable value such as an amount or concentration and the like, is meant to encompass variations of ±10%, f 5%, ±1%, ±0.5%, or even ±0.1% of the specified value as well as the specified value. For example, “about X” where X is the measurable value, is meant to include X as well as variations of ±10%, f 5%, ±1%, ±0.5%, or even ±0.1% of X. A range provided herein for a measurable value may include any other range and/or individual value therein.

As used herein, the terms “increase”, “improve”, and “enhance” (and grammatical variants thereof) refer to an increase in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

Provided herein are surfacing fabrics, which may be used to prepare a composite of the present invention. A surfacing fabric of the present invention may have one or more properties that may increase the performance and/or appearance of the surfacing fabric and/or a composite comprising the surfacing fabric. In some embodiments, the surfacing fabric may have one or more physical and/or surface properties that may increase the performance and/or appearance of the surfacing fabric and/or a composite comprising the surfacing fabric. A surfacing fabric of the present invention may be applied, contacted, and/or bound to a surface of a composite part to enhance one or more physical and/or surface properties of the composite part and/or to enhance the processing of the composite part. Thus, a surfacing fabric of the present invention may act and/or serve as a veil and/or covering on a composite part.

A surfacing fabric, composite, and/or method of the present invention may be more economical than current commercial composites and/or methods for preparing such composites. A surfacing fabric, composite, and/or method of the present invention may be more economical since functional resins and/or chemicals are delivered to a surface of a surfacing fabric and/or composite of the present invention where they are most needed and not to the bulk part of the composite. In contrast, current commercial composites often deliver functional resins and/or chemicals to the bulk part of the composite and may not achieve the surface properties that a surfacing fabric and/or composite of the present invention may achieve. Resins that may be used in a surfacing fabric, composite, and/or method of the present invention include, but are not limited to, specialty resins, commodity core resins, gelcoats, topcoats, and/or bonding pastes.

In some embodiments, a surfacing fabric of the present invention delivers and/or provides one or more properties (e.g., UV resistance, flame retardance, fire resistance, and/or corrosion resistance) to a surface of the surfacing fabric and/or to a surface of a composite of the invention and does not deliver these properties throughout the composite, which may provide economic and/or performance advantages compared to current commercial composites. The surfacing fabric may have the benefit of providing exceptional properties to the surface where needed, while not providing these properties to the whole structure of the composite, and may result in economic benefits and improved performance.

In some embodiments, a surfacing fabric and/or composite of the present invention may have a concentration of a resin and/or performance enhancing agent that is increased by about 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the concentration of a resin and/or performance enhancing agent in a current commercial composite and/or paint. In some embodiments, a surfacing fabric and/or composite of the present invention may provide a concentration of a resin and/or performance enhancing agent that is greater than the concentration of a resin and/or performance enhancing agent in a current commercial composite and/or paint by at least about 2, 3, 4, 5, 6, 7, 8, 9 times or more. In some embodiments, the increased concentration of the resin and/or performance enhancing agent may be increased at a surface of a surfacing fabric and/or composite of the present invention compared to the concentration of the resin and/or performance enhancing agent in a current commercial composite and/or paint. In some embodiments, a resin and/or performance enhancing agent may be more uniformly distributed on a surface of a surfacing fabric and/or composite of the present invention compared to a current commercial composite and/or paint. In some embodiments, a surfacing fabric, composite, and/or method of the present invention may eliminate the need for painting and/or coating a composite to achieve one or more composite properties (e.g., surface properties).

In some embodiments, a surfacing fabric of the present invention comprises a fabric having at least one surface coated with a surfacing resin that may be partially cured. There are stages of curing a resin. “A” staged material is in its raw molecular polymer uncured state. “Partially cured” as used herein refers to a resin that is “B” staged or between “A” and “C” staged, and thus the resin may be later cured, such as, for example, by the application of heat and/or pressure. By “B” staging the surfacing resin on the fabric, numerous chemically reactive sites may be provided. These chemically reactive sites may permit the surfacing fabric to react and/or crosslink with a composite part, (e.g., a fiberglass resin matrix) such that the surfacing fabric and composite part may ultimately become a uniformly cured composite. “Surfacing resin” as used herein refers to a resin that is contacted with a fabric to prepare a surfacing fabric of the present invention. In some embodiments, a surfacing fabric of the present invention may comprise a surfacing resin that is partially cured to a level in which the surfacing fabric can be handled effectively for transportation and/or manufacturing (e.g., commonly accepted composite manufacturing techniques). A partially cured surfacing resin may be achieved according to a method of described herein. A surfacing resin may coat, impregnate, and/or saturate a fabric and may be partially cured. In some embodiments, a partially cured surfacing resin impregnates and/or is throughout the fabric. A surfacing resin and/or a compound in a surfacing fabric of the present invention (e.g., a performance enhancing agent) may increase the performance and/or appearance of the surfacing fabric and/or a composite comprising the surfacing fabric and/or may enhance the processing of a composite part.

The surfacing resin coated on the fabric to prepare the surfacing fabric may be any suitable resin. In some embodiments, the surfacing resin is a specialty and/or performance resin, which may be suitable for a particular application and/use. For example, a specialty and/or performance resin may have particular properties (e.g., physical and/or surface properties) that may make it suitable for ultraviolet (UV) resistance, corrosion resistance, flame retardance, fire resistance, cosmetic appearance enhancements (e.g., color, image, surface profile, etc.), and/or the like. In some embodiments, the surfacing resin may be formulated to have specific surface properties that aid in UV resistance, corrosion resistance, flame retardance, fire resistance, cosmetic appearance enhancements (e.g., color, image, surface profile, etc.), and/or the like. Example surfacing resins that may be coated on a fabric to provide a surfacing fabric of the present invention include, but are not limited to, polyurethane resins, acrylic resins, epoxy resins, phenolic resins, unsaturated polyester resins (e.g., brominated polyester resins), vinyl ester resins, and/or resins under the tradename including, but not limited to: Derakane® epoxy vinyl ester resins commercially available from Ashland, Modar® thermosetting fire-retardant modified acrylic resins commercially available from Ashland, Hetron® fire-retardant halogenated polyester or epoxy vinyl ester resins commercially available from Ashland, Aropol® unsaturated polyester resins commercially available from Ashland, AME® modified epoxy vinyl ester resins commercially available from Ashland, Maxguard® gelcoats that are based on special isophthalic/neopentylglycol (NPG) resins and are commercially available from Ashland, Polylite® polyester resins commercially available from Reichhold, Hydrex® vinyl ester resins commercially available from Reichhold, DION® polyester resins commercially available from Reichhold, Norpol® vinyl ester based bonding pastes commercially available from Reichhold, Advalite™ monomer free, vinyl hybrid resins commercially available from Reichhold, Atlac® bisphenol-A fumarate polyester resins commercially available from Reichhold, Bivirtex® bisphenol-A fumarate polyester resins commercially available from Reichhold, Altek® polyester resins commercially available from AOC, Hydropel® modified vinyl ester resins commercially available from AOC, Pultru® isophthalic polyester resins commercially available from AOC, Vipel® brominated bisphenol A epoxy vinyl ester resins commercially available from AOC, Corezyn® isophthalic and orthophthalic polyester resins commercially available from Interplastic Corporation, Silmar® polyester resins commercially available from Interplastic Corporation, Integrity® gelcoats commercially available from Interplastic Corporation, Creastapol® urethane acrylate resins commercially available from Scott Bader Company Limited, Crystic® polyester resins commercially available from Scott Bader, Rimline® polyurethane resins commercially available from Huntsman Corporation, Baydur® polyurethane resins commercially available from Bayer MaterialScience LLC, and/or Voraforce™ expoxy resins commercially available from The Dow Chemical Company.

In some embodiments, a surfacing fabric of the present invention may comprise a phenolic resin, a brominated polyester resin, and/or a polyester resin including flame resistant materials, such as, but not limited to, alumina trihydrate, phosphorus, and/or metal complexes, which may improve the fire resistance of the surfacing fabric and/or a composite comprising the surfacing fabric.

A composition comprising the surfacing resin may be used to coat a fabric and provide a surfacing fabric of the present invention. The composition may comprise a surfacing resin in an amount of about 20% to about 99% by weight of the composition. In some embodiments, the surfacing resin may be present in the composition in an amount of about 20%, 25%, 30%, 35%, 40%, 45%, 50%, 55%, 60%, 65%, 70%, 75%, 80%, 85%, 90%, 95%, or 100%, or any range therein.

In some embodiments, a composition of the present invention comprises a surfacing resin and at least one performance enhancing agent, and this composition may be used to coat a fabric and provide a surfacing fabric of the present invention. The performance enhancing agent may enhance and/or improve the performance of the surfacing resin, surfacing fabric, and/or composite comprising the surfacing fabric. In some embodiments, inclusion of a performance enhancing agent in the composition comprising the surfacing resin may improve one or more properties (e.g., physical and/or surface properties) of the surfacing resin, surfacing fabric and/or a composite of the present invention. Example performance enhancing agents include, but are not limited to, UV resistance agents (e.g., UV inhibitors and/or light stabilizers, such as, e.g., hindered amines, and/or UV light absorbers), corrosion resistance agents (e.g., corrosion inhibitors (e.g., oxygen corrosion inhibitors), hydrogen absorbers, and/or ceramics (e.g., oxide ceramics and/or ceramic metal mixes), flame retardants, surface enhancing agents, pigments, pearlescents, flatting agents, organic fillers, inorganic fillers, and/or aesthetic agents. In some embodiments, a performance enhancing agent may be present at a surface of a surfacing fabric and/or composite of the present invention and/or throughout a surfacing fabric of the present invention.

A performance enhancing agent may be present in a composition in an amount of about 0.01% to about 20% by weight of the composition. In some embodiments, the performance enhancing agent may be present in the composition in an amount of about 0.01%, 0.05%, 0.1%, 0.5%, 1%, 2%, 3%, 4%, 5%, 6%, 7%, 8%, 9%, 10%, 11%, 12%, 13%, 14%, 15%, 16%, 17%, 18%, 19%, or 20%, or any range therein.

A composition of the present invention may comprise other additives and/or excipients (e.g., 1, 2, 3, 4, 5, 6, 7, 8, 9, 10, or more). For example, the composition comprising the surfacing resin, and optionally a performance enhancing agent, may also comprise an initiator, a mold release agent, a low profile anti-shrink additive, a lubricant, a catalyst, a curing agent, a pigment, and/or a filler material. In some embodiments, one or more additives and/or excipients may enhance the manufacturing process of a composite of the present invention. In some embodiments, the composition may comprise one or more solvents or diluents. In some embodiments, the composition does not comprise a solvent, which may allow for a higher concentration of the surfacing resin and/or a compound (e.g., a performance enhancing agent) at a surface of the surfacing fabric.

One or more additives and/or excipients (e.g., an initiator, pigment, mold release agent, etc.) may each be present in a composition of the present invention in an amount of about 20%, or less. In some embodiments, an additive and/or excipient may be present in the composition in an amount of about 0.01%, 0.05%, 0.1%, 0.5%, 1%, 2%, 3%, 4%, 5%, 6%, 7%, 8%, 9%, 10%, 11%, 12%, 13%, 14%, 15%, 16%, 17%, 18%, 19%, or 20%, or any range therein. In some embodiments, a composition of the present invention may comprise a surfacing resin in an amount of about 50% to about 99% by weight of the composition; an initiator and/or curing agent in an amount of about 0.1% to about 5% by weight of the composition; a mold release agent in an amount of 0.01% to about 5% by weight of the composition; and optionally a performance enhancing agent in an amount of about 0% to about 20% by weight of the composition.

A composition of the present invention comprising a surfacing resin and optionally a performance enhancing agent may be applied to at least one surface of a fabric to provide a surfacing fabric of the present invention. Any suitable fabric may be used. For example, the fabric may be a woven and/or nonwoven fabric that optionally comprises one or more fabric layer(s). A “fabric layer” as used herein refers to a single fabric layer or ply, such as, for example, a single nonwoven fabric layer. In some embodiments, a fabric of the present invention may comprise at least two fabric layers (e.g., 2, 3, 4, 5, 6, or more layers) that may be the same as or different than another layer in the fabric. In some embodiments, the fabric of the surfacing fabric may be used to combine two different resin systems (e.g., the surfacing resin and the composite resin) and/or the fabric may be used as a tie-in layer.

Any suitable woven fabric may be used in a fabric of the present invention. Example woven fabrics that may be used include, but are not limited to, plain weaves, basket weaves, twill weaves, satin weaves, and/or fancy weaves including jacquard weaves, and/or dobby weaves.

Any suitable nonwoven fabric may be used in a fabric of the present invention. Example nonwoven fabrics that may be used in a fabric of the present invention include, but are not limited to, spun melt fabrics, stitchbonded fabrics, needlepunched fabrics, spunlaced fabrics, spunbonded fabrics, thermal bonded fabrics, powder bonded fabrics, chemical bonded fabrics, wet laid fabrics, meltblown fabrics, and/or air laid fabrics.

A woven and/or nonwoven fabric layer that may be used in a fabric of the present invention may be mechanically treated and/or have undergone any suitable mechanical treatment, including, but not limited to, calendaring, creping, embossing, and/or stretching. In some embodiments, a woven and/or nonwoven fabric layer that may be used in a fabric of the present invention may be and/or have been chemically treated for certain properties, such as, but not limited to, flame retardancy, oil, alcohol and/or water repellency, antistatic, antimicrobial, corrosion inhibition, color, opacity, dimensional stability, coefficient of friction, and/or the like.

In some embodiments, a fabric layer of the present invention may have a three-dimensional pattern, such as, for example, a three-dimensional pattern that mimics the three-dimensional texture of a woven textile (e.g., hopsack, terrycloth or twill).

Any suitable fiber may be used in a fabric and/or fabric layer of the present invention in any suitable amount. Fibers may be natural fibers and/or synthetic fibers. Examples of fibers include, but are not limited to, bamboo fibers, cotton fibers, flax fibers, hemp fibers, jute fibers, polylactic acid fibers, silk fiberswool (e.g., alpaca, angora, cashmere, chiengora, guanaco, llama, mohair, pashmina, sheep and/or vicufia) fibers, acrylic fibers, glass fibers, lyocell fibers, melamine fibers, modacrylic fibers, polyacrylonitrile (e.g., oxidized polyacrylonitrile) fibers, polyamide (e.g., nylon and/or aramid) fibers, polyester fibers, polyimide fibers, polylactic acid fibers, polyolefin (e.g., polyethylene and/or polypropylene) fibers, polyvinyl acetate fibers, polyvinyl alcohol fibers, rayon fibers, viscose fibers, modified viscose (e.g., silica-modified viscose) fibers, zylon fibers, and/or bicomponent fibers (e.g., fibers comprising a copolymer and/or fibers comprising two or more polymers (e.g., polyester and polypropylene)). In some embodiments, at least one layer in a fabric of the present invention comprises thermoplastic fibers. In some embodiments, a fabric and/or fabric layer of the present invention comprises polyethylene terephthalate fibers, polypropylene fibers, nylon fibers, glass fibers, fiberglass fibers, carbon fibers, aramid fibers, acrylic fibers, polyester fibers, polyolefin fibers, cellulosic fibers, or blends thereof.

According to some embodiments of the present invention provided are methods of preparing a surfacing fabric of the present invention. A method of preparing a surfacing fabric may comprise contacting at least one surface of a fabric with a surfacing resin, and partially curing the surfacing resin, thereby preparing the surfacing fabric. In some embodiments, a composition of the present invention comprising the surfacing resin may be contacted to at least one surface of the fabric.

Contacting as used herein includes, but is not limited to, to dipping, spraying, extruding, submerging, impregnating, saturating, coating, spreading, resin injecting, calendaring, and/or the like. Thus, in some embodiments, the surfacing resin and/or a composition comprising the surfacing resin may be sprayed, spread, extruded, coated, and/or the like onto at least one surface of the fabric and/or the fabric may be dipped, submerged, impregnated, saturated and/or the like into and/or with the surfacing resin and/or composition comprising the surfacing resin. In some embodiments, the surfacing resin and/or composition may be in the form of a melted liquid and/or mixture. In some embodiments, the surfacing resin may be dissolved in a solvent (e.g., water or an organic solvent) and/or the composition comprising the surfacing resin comprises a solvent.

According to some embodiments, a surfacing fabric of the present invention may be prepared by dipping a fabric into a bath comprising a melted mixture of a surfacing resin and/or a performance enhancing agent, and pressing the fabric between rolls to control add-on. In some embodiments, a surfacing fabric of the present invention may be prepared by dipping a fabric into a bath comprising a composition comprising a surfacing resin and/or a performance enhancing agent that is/are dissolved in a solvent, and pressing the fabric between rolls to control add-on. In some embodiments, a surfacing fabric of the present invention may be prepared by spraying onto the fabric a composition comprising a surfacing resin, optionally a performance enhancing agent, and optionally a solvent. In some embodiments, a surfacing fabric of the present invention may be prepared by coating one or more surfaces of a fabric with a composition comprising a surfacing resin, optionally a performance enhancing agent, and optionally a solvent. In some embodiments, a surfacing fabric of the present invention may be prepared by contacting one or more surfaces of a fabric with a resin dissolved in a solvent and by evaporating the solvent such as, e.g., in an oven and/or drying tower. In some embodiments, a surfacing fabric of the present invention may be prepared by preparing a roll coat (e.g., gravure, flexographic, offset, etc.) fabric using a composition comprising a surfacing resin, optionally a performance enhancing agent, and optionally a solvent. In some embodiments, a surfacing fabric of the present invention may be prepared by one or more methods traditionally used in coating fabric, paper, metal foils, films, and/or the like.

The surfacing resin may be partially cured using methods known to those of skill in the art. As one of ordinary skill in the art will recognize, different resins may be cured and/or partially cured in different ways. In some embodiments, a surfacing resin may be partially cured by cooling the surfacing fabric and/or the surfacing resin to room temperature and/or ambient conditions.

A surfacing fabric of the present invention may be part of a composite of the present invention. In some embodiments, the surfacing fabric may act and/or serve as a “skin”. The surfacing fabric may chemically react and/or bond to a composite resin and/or reinforcing material. In some embodiments, a surfacing fabric of the present invention may be used to solve fiber reinforced polymer composite deficiencies.

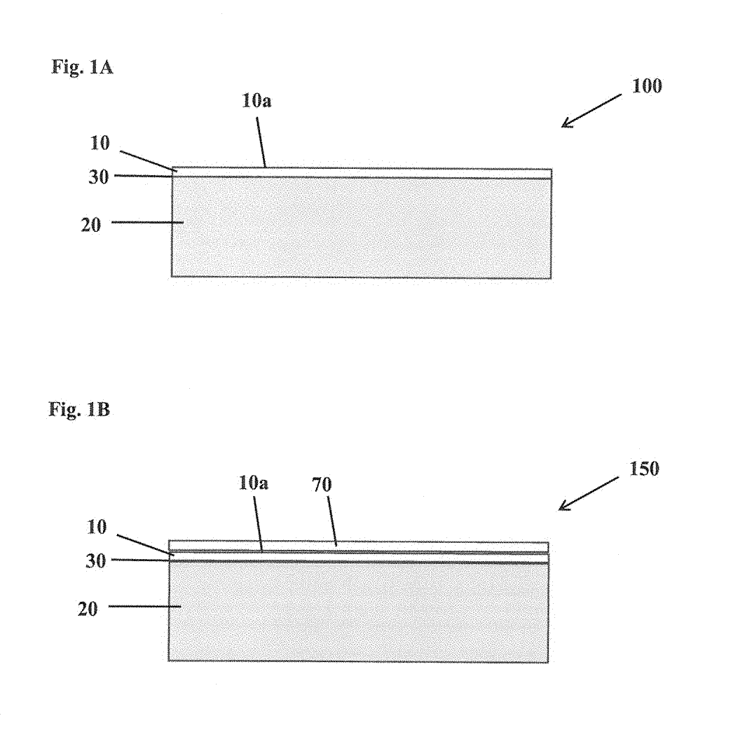

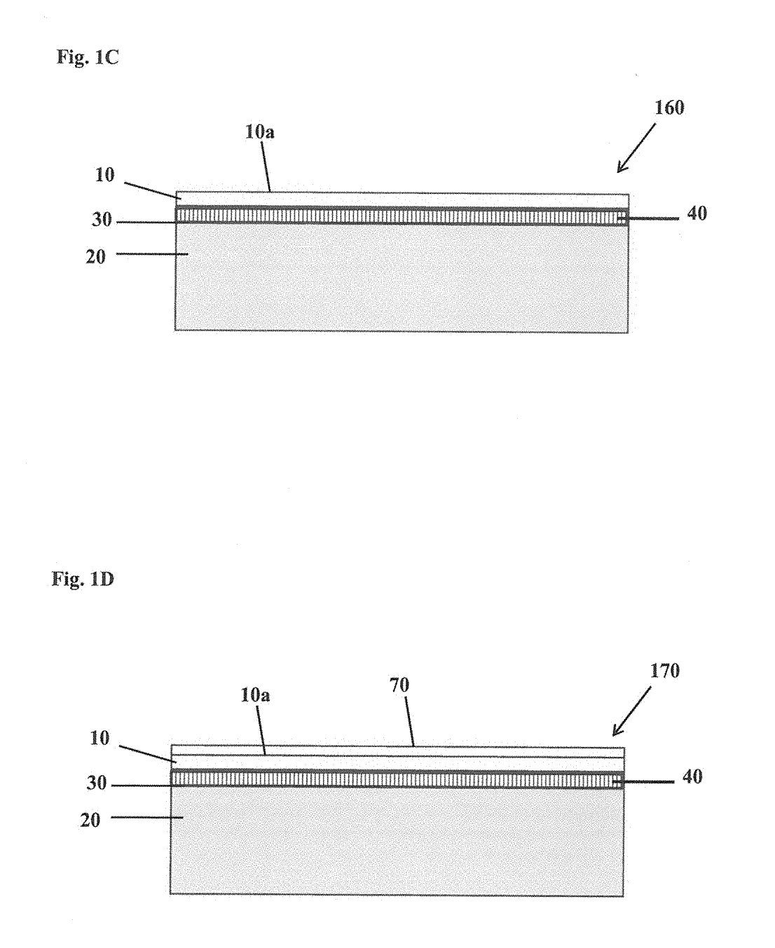

A composite of the present invention may comprise a surfacing fabric of the present invention, a reinforcing material, and a composite resin. Referring now to FIG. 1A, a composite 100 of the present invention may comprise a surfacing fabric 10, a reinforcing material 20, and a composite resin 30 that may at least be present between the surfacing fabric 10 and reinforcing material 20. In some embodiments, the composite resin 30 may be present throughout the reinforcing material 20 and/or throughout at least a portion of the surfacing fabric 10 (e.g., a portion adjacent to and/or in contact with the reinforcing material 20). In some embodiments, the composite resin 30 is not present at the exterior surface of the surfacing fabric 10a. In some embodiments, the surfacing fabric 10 may be placed on and/or bound to a surface of a reinforcing material 20, optionally comprising the composite resin 30, such that the surfacing fabric 10 may cover and/or protect the reinforcing material 20. The exterior surface of the surfacing fabric 10a may be an exterior surface of the composite 100. Thus, in some embodiments, the surfacing resin on the surfacing fabric 10 may form an exterior surface of the composite 100. In some embodiments, surface 10a may be glossy.

Example properties for surfacing fabric 10 are provided in Table 1. In some embodiments, a surfacing fabric 10 may comprise a fabric that has: a basis weight in a range of about 0.1 or 0.5 oz/square yard to about 2, 3, 4, or 5 oz/square yard; a thickness in a range of about 0.001 or 0.01 inch to about 0.02, 0.05, or 0.1 inch; a grab tensile strength in the machine direction in a range of about 15 or 20 lbs. to about 45 or 50 lbs.; a grab tensile strength in the cross machine direction in a range of about 5 or 10 lbs. to about 35 or 45 lbs.; an air permeability in a range of about 250 or 500 cfm to about 600 or 750 cfm; and/or a pore size of about 100 microns to about 500, 1,000 or 30,500 microns or about 20,000 microns to about 30,500 microns. In some embodiments, surfacing fabric 10 may have: a basis weight in range of about 6, 7, or 8 osy to about 9, 10, 11, or 12 osy; a grab tensile strength in the machine direction in a range of about 15 or 20 lbs. to about 45 or 50 lbs.; a grab tensile strength in the cross machine direction in a range of about 5 or 10 lbs. to about 35 or 45 lbs.; a thickness in a range of about 0.001 or 0.01 inch to about 0.02, 0.05, or 0.1 inch; an air permeability in a range of about 20, 25, 30, 35, or 40 cfn to about 45, 50, 60, 70, 75, or 80 cfm; and/or a pore size of less than about 24,500, 15,000, 10,000, 5,000, 1,000, 750, 500, 250, 150, 100 or 50 microns. In some embodiments, a surfacing resin may be added onto a fabric in an amount of about 1, 2, 3, 4, 5, 6, or 7 osy to about 8, 9, or 10 osy to provide surfacing fabric 10.

TABLE 1
Example physical properties for surfacing fabric 10.

| | Solution- | Heatset | |
|---|---|---|---|
| | dyed black | apertured | |
| | spunlace | spunlace | |
| | PET | PET | Method |
| Property of fabric prior | | | |
| to resin application | | | |
| PFG style | 19124 | 111-90010 | Not applicable |
| basis weight (oz./sq. yd.) | 1.89 | 1.08 | ASTM D3776 |
| thickness (in.) | 0.020 | 0.0113 | ASTM D1777 |
| grab tensile - md (lb.) | 42.0 | 25.14 | ASTM D5034 |
| grab tensile - xd (lb.) | 33.8 | 15.6 | ASTM D5034 |
| airperm (cfm) | 353 | 637 | ASTM D737 |
| pore size (microns) | 168 | 24500.00 | ASTM E 1294-89 |
| Property of fabric after | | | |
| resin application | | | |
| Surfacing Resin Add-On | 7.4 osy | 7.5 osy | (Weight coated |
| (ounces per square yard | | | fabric − weight of |
| of fabric) | | | uncoated fabric) |
| Basis weight (oz./sq. yd.) | 9.3 osy | 8.6 osy | (Weight coated, |
| of Surfacing Fabric 10 | | | fabric) |
| (base fabric + resin) | | | |
| Thickness (in.) | 0.0185 | 0.0158 | ASTM D1777 |
| Airperm (cfm) | 31.9 | 63.3 | ASTM D737 |

In some embodiments, a composite 150 may include a fabric and/or film 70 that is on the surface 10a of the surfacing fabric 10 as shown in FIG. 1B. The fabric and/or film 70 may be a surfacing veil as known to those of skill in the art. The fabric and/or film 70 may function as a release layer and/or may prevent adhesion of the surfacing fabric 10 to manufacturing equipment (e.g., pultrusion die). This may enable and/or improve processing of the composite 150 such as, e.g., in a pultrusion process. For example, the surfacing fabric 10 may adhere and/or stick to the interior of a pultrusion die, which can make the pultursion process impossible or difficult, so the fabric and/or film 70 layer may be added. In some embodiments, the fabric and/or film 70 may provide sufficient lubricity and/or release to allow the composite 150 to proceed through a pultrusion die. The fabric and/or film 70 can be part of the composite 150, and may remain a component of the final composite part. Alternatively or in addition, the fabric and/or film 70 may be stripped and/or removed from the composite 150 after the composite 150 is formed (e.g., after a pultrusion process creating the composite 150). In some embodiments, when the fabric and/or film 70 is removed from composite 150 (e.g., after the forming process), a clean and/or pure surface 10a of the surfacing fabric 10 may be provided (e.g., the surface 10a may be the surfacing resin of the surfacing fabric 10). In some embodiments, composite resin 30 may migrate to and/or be present at surface 10a of the surfacing fabric, but, in some embodiments, the composite resin 30 may be removed from surface 10a when the fabric and/or film 70 is removed from the composite 150, which may thereby provide a surface free or substantially free (e.g., less than 10%, 5% or 1% of the composite resin 30 at surface 10a) of the composite resin 30. This can be important because the composite resin 30 at surface 10a may reduce and/or eliminate one or more properties provided by the composite 150 (e.g., UV protection, flame retardance, appearance, color, etc.). In some embodiments, after the fabric and/or film 70 is removed from composite 150, surface 10a may be matte. “Matte” as used herein refers to a surface having less than about 5% reflectance (e.g., less than about 5%, 4%, 3%, 2%, 1%, 0.5%, or less reflectance) when measured at a 60 degree angle.

In some embodiments, the fabric and/or film 70 blocks and/or provides a space between the composite resin 30 and/or the surfacing resin and an interior wall of the pultrusion die. In some embodiments, the fabric and/or film 70 has melt properties such that the fabric and/or film 70 does not melt at the pultrusion process temperature(s) (e.g., about 170° C. to about 180° C.) and/or does not adhere to the interior of the pultrusion die.

When the fabric and/or film 70 is a film, the film 70 may be a continuous layer, which may prevent the composite resin 30 and/or the surfacing resin from adhering to the interior of the pultrusion die. When the fabric and/or film 70 is a fabric, the fabric 70 may have a thickness and/or permeability that prevent the composite resin 30 and/or the surfacing resin from adhering to the interior of the pultrusion die. In some embodiments, a fabric 70 may have a thickness of at least about 0.001 inches (e.g., about 0.001 to about 0.1 inches) and/or a permeability of about 2000 cfm or less as measured with air permeability (e.g., about 1 cfm to about 2000 cfm).

Tensile strength, tear resistance and/or elongation of the fabric and/or film 70 may be adjusted depending on the composite and/or process. In some embodiments, the fabric and/or film 70 has a basis weight in a range of about 0.1 osy to about 1, 2, 3, or 4 osy; a thickness of about 0.001 inch to about 0.01 or 0.1 inch; a MD and/or CD grab tensile strength of at least about of 2 lbs (e.g., about 2 or 5 lbs to about 10, 20, or 30 lbs); MD and/or CD elongation percentage of at least about 3% (e.g., about 3% or 10% to about 20%, 40%, 60%, or 80%); a MD and/or CD trap tear strength of at least about 2 lbs (e.g., about 2 to about 10 lbs); a pore size of about 1, 10, or 20 microns to about 5, 10, 25, or 35 microns; and/or an air permeability of about 500, 600, or 800 cfm to about 900, 1200 or 1500 cfm or about 1, 10, 20, or 40 cfm to about 10, 20, 30, or 60 cfm. Example fabrics for the fabric and/or film 70 are provided in Tables 2 and 3.

TABLE 2
Example Fabric 70 Physical Properties

| | Polyester | Polyester | Spunbond | |
|---|---|---|---|---|
| | Spunbond | Spunbond | Glass | Test Method |
| Basis Weight osy | 0.56 | 1.25 | 1.17 | ASTM D3776 |
| Thickness inches | 0.005 | 0.008 | 0.015 | ASTM D1777 |
| Grab Tensile MD lb | 6 | 16.8 | est. 18 | ASTM D-5034 |
| Elongation MD % | 6.3 | 40.3 | est. 3 | ASTM D-5034 |
| Grab Tensile XD lb | 5.4 | 17.0 | est. 18 | ASTM D-5034 |
| Elongation XD % | 45 | 68.2 | est. 2 | ASTM D-5034 |
| Trap Tear MD lb | na | 4.4 | est. 5 | ASTM D-5733 |
| Trap Tear XD lb | na | 6.0 | est. 5 | ASTM D-5733 |
| Air Perm cfm | 1350 | 632 | est. 650 | ASTM D-737 |

TABLE 3
Further Example Fabric 70 Physical Properties

| Fiber | Polyester | Polyester | Nylon | |
|---|---|---|---|---|
| Construction | Woven | Woven | Woven | Test Method |
| Basis Weight osy | 2.92 | 2.53 | 1.7 | ASTM D3776 |
| Warp Yarn denier | 250/48 | 75/36 | 2.53 | ASTM D 6612 |
| Fill Yarn deiner | 250/48 | 75/36 | 2.92 | ASTM D 6612 |
| Thickness inches | .0063 | .0059 | .0044 | ASTM D1777 |
| Air Perm cfm | 17.9 | 3.8 | 48.8 | ASTM D-737 |
| Pore Size microns | 25.95 | 6.5 | 23.26 | ASTM E-1294-89 |

Referring now to FIG. 1C, in some embodiments, a composite 160 may include an anti-migration layer 40 between a surfacing fabric 10 and a reinforcing material 20. The anti-migration layer 40 may be a nonwoven fabric, such as, but not limited to, a spun melt fabric, stitchbonded fabric, needlepunched fabric, spunlaced fabric, spunbonded fabric, thermal bonded fabric, powder bonded fabric, chemical bonded fabric, wet laid fabric, meltblown fabric, and/or air laid fabric. In some embodiments, the anti-migration layer may comprise glass and/or polyester fibers. The anti-migration layer 40 may have a basis weight of about 0.5 or 1 osy to about 3, 4, or 5 osy; a thickness of about 0.001 inch to about 0.01 or 0.1 inch; a grab tensile strength in the machine direction of about 30 or 35 lbs to about 55 or 60 lbs; an elongation percentage in the machine direction of about 20% to about 40%; a grab tensile strength in the cross machine direction of about 10 or 15 lbs to about 35 or 40 lbs; an elongation percentage in the cross machine direction of about 130% to about 150%; a trap tear strength in the machine direction of about 1 or 5 lbs to about 15 or 20 lbs; a trap tear strength in the cross machine direction of about 15 or 20 lbs to about 35 or 40 lbs; an air permeability of about 80 or 90 cfm to about 110 or 125 cfm; and/or a pore size of about 60 or 70 microns to about 90 or 100 microns. In some embodiments, the anti-migration layer 40 is a spunlace fabric (e.g., a 2.0 osy polyethylene terephthalate (PET) spunlace fabric). Example anti-migration layer physical properties 40 are provided in Table 4.

TABLE 4
Example anti-migration layer physical properties

| | Polyester | |
|---|---|---|
| | Spunlace | Test Method |
| Basis Weight osy | 2.0 | ASTM D3776 |
| Thickness inches | 0.007 | ASTM D1777 |
| Grab Tensile MD lb | 47.53 | ASTM D-5034 |
| Elongation MD % | 32.73 | ASTM D-5034 |
| Grab Tensile XD lb | 26.37 | ASTM D-5034 |
| Elongation XD % | 141.17 | ASTM D-5034 |
| Trap Tear MD lb | 10.83 | ASTM D-5733 |
| Trap Tear XD lb | 29.23 | ASTM D-5733 |
| Air Perm cfm | 99 | ASTM D-737 |
| Pore Size microns | 79 | ASTM E 1294-89 |

An anti-migration layer 40 may prevent or reduce migration of a resin (e.g., composite resin 30 and/or commodity resin) to and/or through the surfacing fabric 10, at the surface 10a, and/or onto a surface of the composite part. The composite resin 30 may at least be present between the anti-migration layer 40 and reinforcing material 20. Presence of composite resin 30 on a composite part, in the surfacing fabric 10, and/or at surface 10a of the surfacing fabric 10 may diminish the impact of a surfacing resin in the surfacing fabric 10. In some embodiments, the surfacing resin of the surfacing fabric 10 is present at the exterior surface of the surfacing fabric 10a.

In some embodiments, a composite 170 may include an anti-migration layer 40 between a surfacing fabric 10 and a reinforcing material 20, and a fabric and/or film 70 that is on the surface 10a of the surfacing fabric 10 as shown in FIG. 1D.

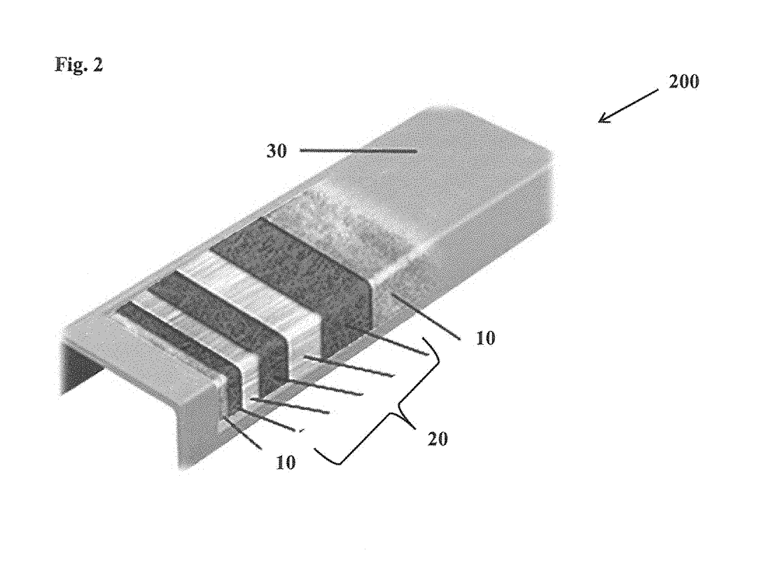

Referring now to FIG. 2, which is a cutaway illustration of a composite 200 of the present invention, in which a composite resin 30 may be present at an exterior surface of the composite 200 and may be present throughout the layers of the composite 200. As shown in FIG. 2, a surfacing fabric 10 of the present invention may be above and below a reinforcing material 20, and the reinforcing material 20 may comprise two or more layers that may be the same or different.

A composite of the present invention may have any suitable thickness. In some embodiments, a composite of the present invention may have a thickness in a range of about 0.05 to about 2 inches, such as, for example, about 0.05, 0.075, 0.1, 0.25, 0.5, 0.75, 1, 1.25, 1.5, 1.75, or 2 inches or any range therein.

A composite of the present invention may be a solid unitary layer having any suitable thickness. In some embodiments, while the composite is made up of at least two different layers of material, the cured composite may form a solid unitary layer. The composite may be a solid continuous plastic.

A surfacing fabric of the present invention may be a subassembly for a composite of the present invention. A surfacing fabric of the present invention comprises a surfacing resin, such as, for example, a performance resin that may provide one or more surface properties to the surfacing fabric and/or composite comprising the surfacing fabric. In some embodiments, the surfacing resin on the surfacing fabric may comprise at least one performance enhancing agent (e.g., a UV stabilizer), which may provide one or more surface properties to the surfacing fabric and/or composite, and/or may comprise a mold release agent, and/or other performance additives and/or excipients.

A composite of the present invention may be prepared using a composite resin that may be different than the surfacing resin used to prepare the surfacing fabric. Thus, a composite of the present invention may comprise at least two different resins. The composite resin and surfacing resin may be compatible (e.g., chemically compatible) and/or may bind and/or mold together with sufficient strength. In some embodiments, the surfacing resin and the composite resin are the same. In some embodiments, the surfacing resin and the composite resin are the same, and the surfacing fabric comprises the surfacing resin and at least one performance enhancing agent.

In some embodiments, a composite of the present invention may be a fiber reinforced plastic (FRP), which is a material obtained by a series of processes in which fibrous materials (e.g., glass, aramid, graphite, etc.) are combined with resinous materials, such as, for example, thermosetting and/or thermoplastic resins, to make a shape that is stronger than the resin itself.

The composite resin (e.g., a thermosetting resin and/or a thermoplastic resin) may bind the surfacing fabric to the reinforcing material. In some embodiments, the surface of the surfacing fabric coated with the surfacing resin (e.g., performance and/or specialty resin) is an outer surface of the composite and/or faces the exterior of the composite. The binding and/or adhesion of the surfacing fabric to the reinforcing material may be sufficient for the end use of the composite. In some embodiments, the surfacing fabric is in contact with and/or binds to the reinforcing material and masks the reinforcing material and/or composite resin (e.g., a bulk commodity resin) and provides one or more properties to the surface of the composite.

In some embodiments, the composite resin may coat, impregnate, and/or saturate the surfacing fabric and/or the reinforcing material. In some embodiments, the composite resin impregnates and/or is throughout the surfacing fabric and/or the reinforcing material. In some embodiments, the composite resin does not impregnate the surfacing fabric. In some embodiments, the composite resin does not substantially affect and/or reduce the properties (e.g., physical and/or surface properties) provided by the surfacing fabric.

Any suitable thermosetting resin and/or thermoplastic resin may be used as a composite resin to prepare a composite of the present invention. A thermosetting resin is one which cures or polymerizes and cannot be melted and reshaped with the application of heat. In some embodiments, the thermosetting resin is a bulk commercial resin. Thermosetting resins encompass a wide range of materials and examples include, but are not limited to, polyester resins, vinyl ester resins, bisphenol resins, phenolic resins, polyurethane resins, acrylic resins, epoxy, and any combination thereof. Example thermoplastic resins include, but are not limited to, polyethylene terephthalate (PET), polypropylene (PP), polyphenylene sulfide (PPS), polylactic acid (PLA), polycarbonate, PBT, vinyl, polyethylene, PVC, PEI, and/or nylon.

A composite of the present invention may comprise any suitable reinforcing material. Example reinforcing materials include, but are not limited to, natural and/or synthetic fibers, such as, e.g., fiberglass fibers, polyester fibers, polypropylene fibers, polyethylene fibers, nylon fibers, inorganic fibers, quartz fibers, basalt fibers, aramid fibers, and/or carbon fibers. Reinforcing materials may be in any form, including, but not limited to, weaves, knits, braids, rovings, stitches, and/or the like. The reinforcing material may comprise one or more layers, such as, for example, 1, 2, 3, 4, 5, 6, 7, 8, 9, 10, or more layers.

According to some embodiments of the present invention, methods of preparing a composite of the present invention are provided. A method of preparing a composite of the present invention may comprise placing a composite resin (e.g., a thermosetting resin) between a reinforcing material and a surfacing fabric of the present invention, and curing the composite resin, thereby preparing the composite. The composite resin binds the surfacing fabric to the reinforcing material and may be different than the surfacing resin provided on the surfacing fabric. The surfacing resin provided on at least one surface of the surfacing fabric may be facing an outer surface of the composite. In some embodiments, a fabric and/or film may be on at least one surface of the exterior of the composite. In some embodiments, a fabric and/or film may be on at least one surface of the surfacing fabric of the composite (e.g., the fabric and/or film may be on the surface of the surfacing fabric opposing the surface of the surfacing fabric that is facing the reinforcing material). The fabric and/or film may be designed to enable and/or enhance processing of the composite such as, e.g., in a pultrusion process. The fabric and/or film may cover a portion, a majority, and/or substantially all (e.g., at least 90%) of a surface of the composite and/or surfacing fabric. In some embodiments, the fabric and/or film covers at least about 50%, 55%, 60%, 65%, 70%, 75%, 80%, 85%, 90%, 95%, 97%, 98%, 99%, or 100% of a surface of the composite and/or surfacing fabric (e.g., the surface of the surfacing fabric opposing the surface of the surfacing fabric that is facing the reinforcing material). In some embodiments, the fabric and/or film covers at least about 90%, 95%, 97%, 98%, 99%, or 100% of a surface of the surfacing fabric (e.g., the surface of the surfacing fabric opposing the surface of the surfacing fabric that is facing the reinforcing material).

Various methods known to those of skill in the art may be used to place a composite resin between the reinforcing material and the surfacing fabric. For example, a reinforcing material may be contacted (e.g., submerged, impregnated, sprayed, resin injected, etc.) with the composite resin such that at least one surface of the reinforcing material contains the composite resin and a surfacing fabric may be placed in contact with the at least one surface of the reinforcing material containing the composite resin. In some embodiments, the reinforcing material is impregnated with the composite resin.

Example methods that may be used to prepare a composite of the present invention include, but are not limited to, pultrusion, filament winding, resin transfer molding (RTM), contact molding, continuous panel molding, hand lay-up, and/or vacuum infusion.

In some embodiments, a composite of the present invention may be prepared by saturating and/or wetting-out a reinforcement material with a liquid composite resin (e.g., a liquid thermosetting resin). A surfacing fabric may be placed on top of the saturated and/or wet reinforcement material to form the composite. The composite may be shaped either manually or mechanically into the form of the finished article such as a part. The composite (optionally after being formed) may be allowed to cure via the polymerization of the composite resin and/or surfacing resin. Thus, the surfacing resin may be fully cured once the composite is prepared. Curing may be accomplished by a specific time and/or temperature relationship based on the formulation of the resin(s).

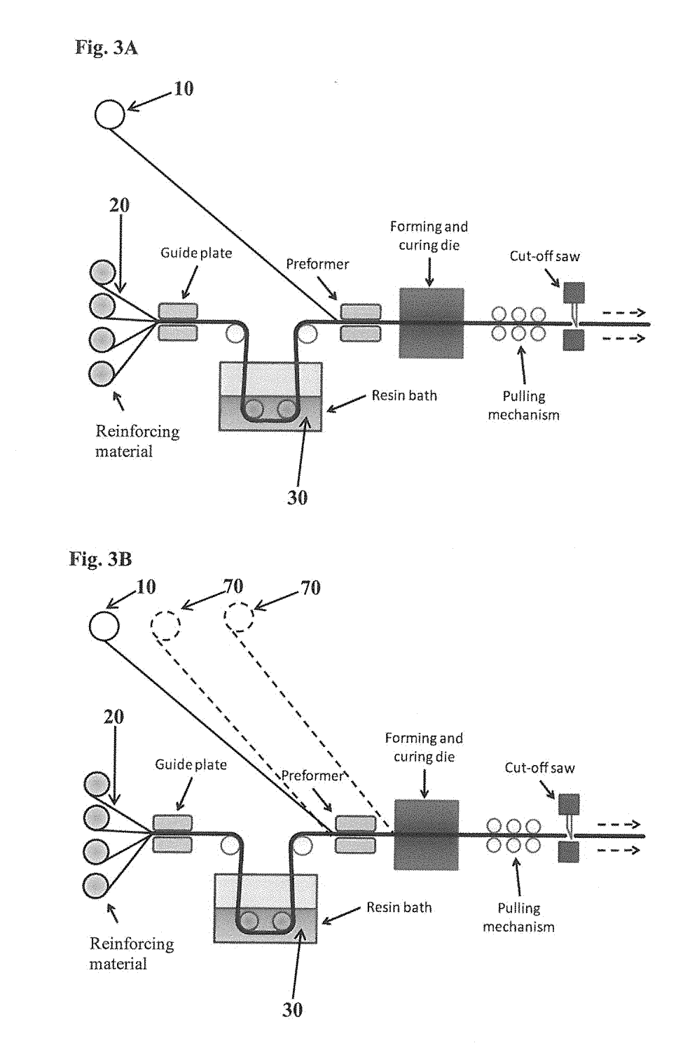

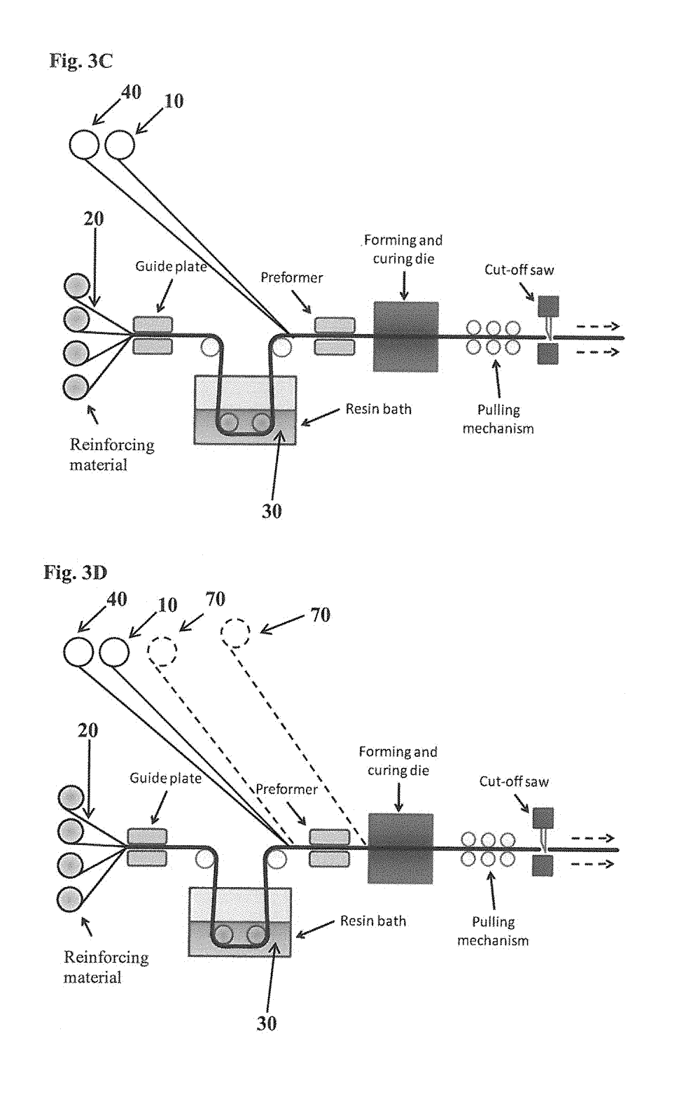

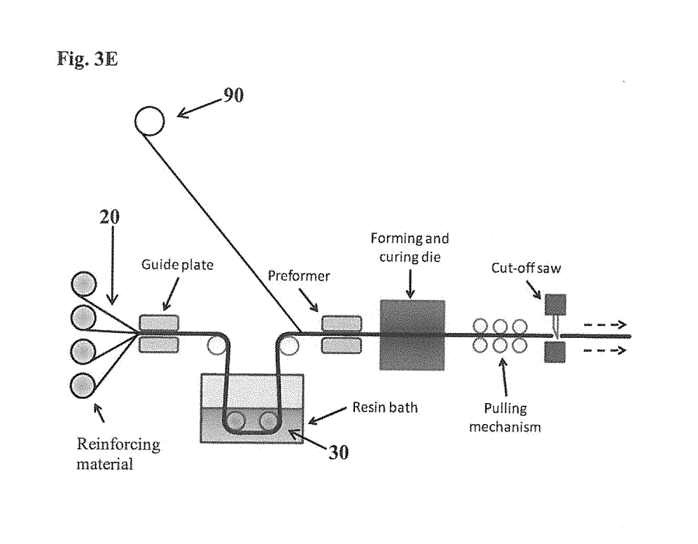

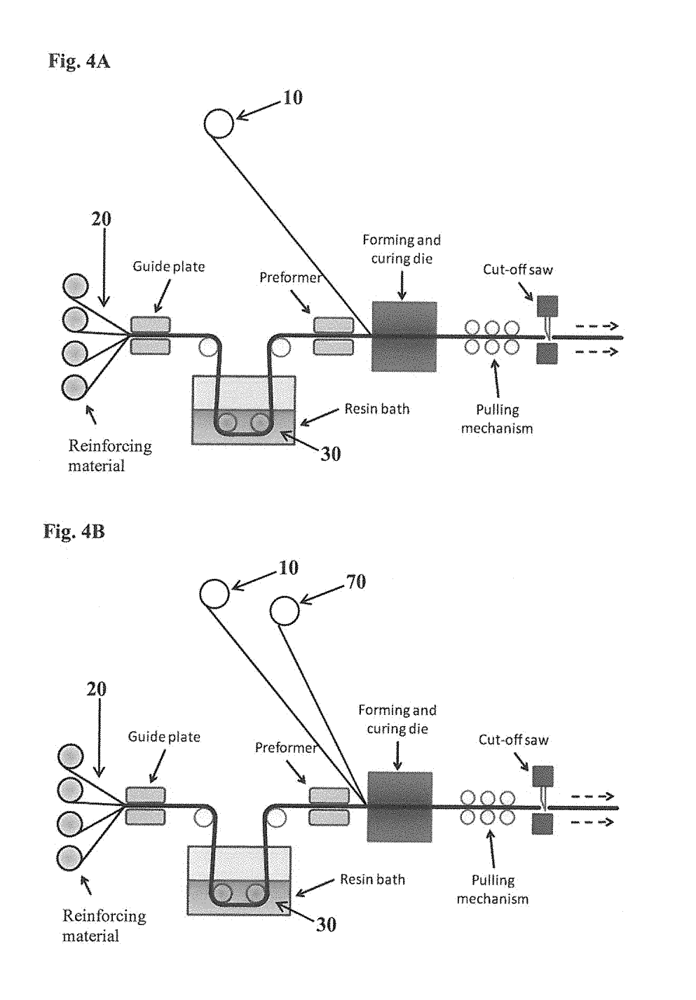

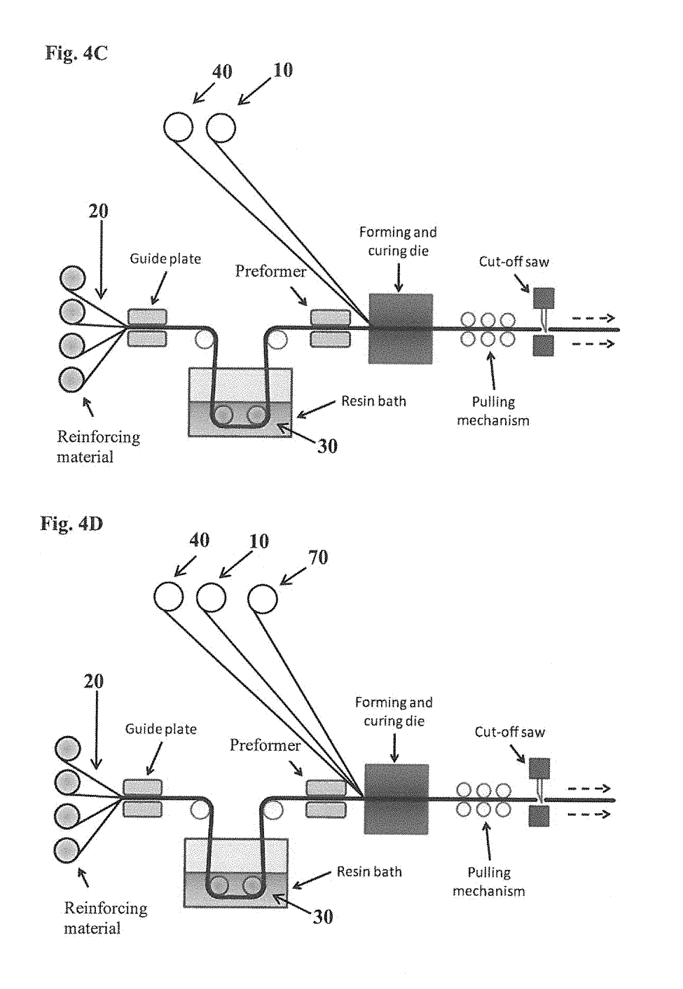

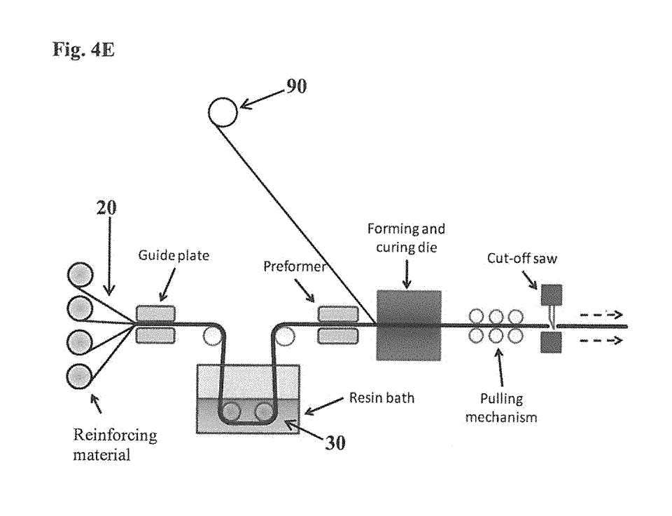

Pultrusion may be used to draw a reinforcing material through a resin bath comprising a composite resin to achieve wet-out. The wet reinforcing material may then be contacted with the surfacing fabric to form the composite and the composite may be pulled through a mold in the shape of the desired article and/or part. Typically, the mold is heated to accelerate the polymerization of the resin(s). Referring now to FIG. 3A, an example method of manufacturing a composite of the present invention is illustrated using a pultrusion process. As shown in FIG. 3A, a roll containing a surfacing fabric 10 of the present invention is separate from the other rolls that provide a reinforcing material 20. The reinforcing material 20 is drawn through a resin bath containing a composite resin 30 to achieve wet-out of the reinforcing material 20. Then, the surfacing fabric 10 may be contacted to the reinforcing material 20 prior to preforming. Alternatively or in addition, as shown in FIG. 4A, the surfacing fabric 10 may be contacted to the reinforcing material 20 after preforming and prior to forming and curing.

A fabric and/or film may 70 be applied to a surface of the surfacing fabric 10 as shown in FIG. 3B with the fabric and/or film 70 being contacted to the surfacing fabric 10 prior to preforming or after preforming and prior to forming and curing (as shown in dashed lines). Alternatively or in addition, as shown in FIG. 4B, the surfacing fabric 10 and the fabric and/or film 70 may be contacted to the reinforcing material 20 after preforming and prior to forming and curing.

Referring now to FIG. 3C, when an anti-migration layer 40 is present, the anti-migration layer 40 and the surfacing fabric 10 may be contacted to the reinforcing material 20 prior to preforming. When a fabric and/or film 70 is present, as shown in dashed lines, the fabric and/or film 70 may be contacted to the surfacing fabric 10 prior to preforming or after preforming and prior to forming and curing as shown in FIG. 3D.

Alternatively or in addition, as shown in FIG. 4C, an anti-migration layer 40 and surfacing fabric 10 may be contacted to the reinforcing material 20 after preforming and prior to forming and curing. When a fabric and/or film 70 is present, the fabric and/or film 70 may be contacted to the surfacing fabric 10 after preforming and prior to forming and curing as shown in FIG. 4D.

Referring now to FIGS. 3E and 4E, a material 90 may include a surfacing fabric, anti-migration layer, and/or a fabric and/or film, and material 90 may be contacted to the reinforcing material 20 prior to preforming (FIG. 3E) and/or after preforming and prior to forming and curing (FIG. 4E).

Contact molding or open molding is another process that may be used in accordance with embodiments of the present invention. Composite resins and/or reinforcing materials are manually (hand lay-up) or mechanically (spray-up) deposited on an open mold surface. The mold surface may be previously coated with a gel coat and/or may be provided with a surfacing fabric of the present invention. Once the desired amounts of reinforcement material and composite resin have been deposited on the mold, the composite is worked with rollers, brushes or squeegees, usually manually, to remove any trapped air and thoroughly saturate or wet-out the reinforcement material and/or surfacing fabric with the composite resin. Once this is completed, the composite is allowed to cure, normally at ambient temperature.

Resin transfer molding (RTM), structural reaction injection molding (S-RIM), and closed molding are three similar closed mold processes and may be used by placing a surfacing fabric of the present invention in one-half of a mold cavity, usually the bottom half. Once properly positioned, the other half (e.g., top half) of the mold is closed and the two halves are secured in place. Next, composite resin (e.g., a bulk commodity resin) is injected either slowly under minimal (e.g 50 psi) pressure in RTM or rapidly under high pressure (e.g. 2000 psi) in S-RIM. The mechanical pumping and resulting pressure causes air to be flushed out of the mold cavity and the composite resin to saturate or wet-out the reinforcing material and/or surfacing material, which is then allowed to cure.

Compression molding is another mold process. In this process, a surfacing fabric of the present invention, reinforcing material, and a composite resin (e.g., a bulk commodity resin) are placed on one-half, usually the bottom half, of the mold cavity. Once properly positioned, the other half (e.g., top half) of the mold is mechanically closed on the half containing the surfacing fabric and composite resin using a press which compresses the surfacing fabric, reinforcing material, and composite resin under pressure (e.g., from 50 to 1500 psi) to flush out air and thoroughly saturate or wet-out the reinforcing material and/or surfacing fabric with the composite resin. Curing may then be performed, optionally with the assistance of heat.

Filament winding is a process in which reinforcing materials, normally continuous rovings, are saturated with a composite resin, normally by pulling them through a pan or bath containing the composite resin. The reinforcing materials are then wound on a rotating mandrel in a specific pattern. The mandrel may or may not have been previously covered with a surfacing fabric of the present invention. In some embodiments, a surfacing fabric of the present invention may be wrapped over the composite resin impregnated reinforcing materials. Once the surfacing fabric is in contact with the reinforcing material, curing may be performed with or without the assistance of heat.

A continuous panel process is a process for making continuous flat and/or shaped, e.g. corrugated, panels. It involves depositing a composite resin on a carrier film which then passes under a reinforcing material deposition area where reinforcing materials are applied to the film with the composite resin. The reinforcing materials and composite resin may then go through a compaction section where a series of belts, screens, and/or rollers force air out and thoroughly saturate or wet-out the reinforcing materials with the composite resin. A surfacing fabric of the present invention may then be placed on the surface of the resulting saturated reinforcing materials and the surfacing fabric may or may not be saturated with the composite resin. In some embodiments, a carrier film may be applied to the top surface of the resulting article. Curing may be performed, optionally with the assistance of heat.

In some embodiments, a surfacing fabric of the present invention may have increased UV resistance and/or durability and/or may provide a composite of the present invention with increased UV resistance and/or durability by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the UV resistance and/or durability of a current commercial composite, optionally comprising a paint, and/or compared to the UV resistance and/or durability of a composite without the surfacing fabric (i.e., a composite in the absence of a surfacing fabric of the present invention). In some embodiments, a surfacing fabric and/or composite of the present invention may provide a UV resistance and/or durability that is greater than the UV resistance and/or durability of a current commercial composite optionally comprising a paint and/or to the composite without the surfacing fabric by at least about 2, 3, 4, 5, 6, 7, 8, 9 times or more. UV resistance and/or durability may be measured using methods known to those of skill in the art, such as, for example, ASTM D2565-2008 Standard practice for Xenon Arc exposure of plastics intended for outdoor applications, ASTM D1435-13 Standard Practice for Outdoor Weathering of Plastics, ASTM D4329-13 Standard Practice for Fluorescent Ultraviolet (UV) Lamp Apparatus Exposure of Plastics, and/or ASTM G 53 QUV Testing replaced by ASTM G154Standard Practice for Operating Fluorescent Ultraviolet (UV) Lamp Apparatus for Exposure of Nonmetallic Materials.

In some embodiments, a surfacing fabric of the present invention may have increased corrosion resistance and/or may provide a composite of the present invention with increased corrosion resistance by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the corrosion resistance of a current commercial composite optionally comprising a paint and/or compared to the corrosion resistance of a composite without the surfacing fabric. In some embodiments, a surfacing fabric and/or composite of the present invention may provide a corrosion resistance that is greater than the corrosion resistance of a current commercial composite optionally comprising a paint and/or to the composite without the surfacing fabric by at least about 2, 3, 4, 5, 6, 7, 8, 9 times or more. Corrosion resistance may be measured using methods known to those of skill in the art, such as, for example, ASTM C 581 Standard Practice for Determining Chemical Resistance of Thermosetting Resins Used in Glass-Fiber-Reinforced Structures Intended for Liquid Service, ASTM C 582 Standard Specification for Contact-Molded Reinforced Thermosetting Plastic (RTP) Laminates for Corrosion-Resistant Equipment, and/or ASTM D7705 Standard Test Method for Alkali Resistance of Fiber Reinforced Polymer (FRP) Matrix Composite Bars used in Concrete Construction.

In some embodiments, a surfacing fabric of the present invention may have increased flame retardance and/or may provide a composite of the present invention with increased flame retardance by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the flame retardance of a current commercial composite optionally comprising a paint and/or compared to the flame retardance of a composite without the surfacing fabric. In some embodiments, a surfacing fabric and/or composite of the present invention may provide a flame retardance that is greater than the flame retardance of a current commercial composite optionally comprising a paint and/or to the composite without the surfacing fabric by at least about 2, 3, 4, 5, 6, 7, 8, 9 times or more. Flame retardance may be measured using methods known to those of skill in the art, such as, for example, UL94 Underwriters Labs Flammability Standard, ASTM E84 Standard Test Method Burning Characteristics of Building Materials, ASTM E162 Standard Test Method for Surface Flammability of Materials Using a Radiant Heat Energy Source, ASTM E119 Standard Test Methods for Fire Tests of Building Construction and Materials, and/or BSS 7239 Toxicity Test to Aircraft Materials.

In some embodiments, a surfacing fabric of the present invention may have increased strength and/or may provide a composite of the present invention with increased strength by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the strength of a current commercial composite optionally comprising a paint and/or compared to the strength of a composite without the surfacing fabric. In some embodiments, a surfacing fabric and/or composite of the present invention may provide a strength that is greater than the strength of a current commercial composite optionally comprising a paint and/or to the composite without the surfacing fabric by at least about 2, 3, 4, 5, 6, 7, 8, 9 times or more. Strength may be measured using methods known to those of skill in the art, such as, for example, ASTM D-638 Tensile Stress and Modulus, ASTM D-695 Compressive Stress and Modulus, and/or ASTM D-790 Flexural Stress and Modulus.

In some embodiments, a surfacing fabric of the present invention may have increased durability and/or may provide a composite of the present invention with increased durability by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the durability of a current commercial composite optionally comprising a paint and/or compared to the durability of a composite without the surfacing fabric. In some embodiments, a surfacing fabric and/or composite of the present invention may provide a durability that is greater than the durability of a current commercial composite optionally comprising a paint and/or to the composite without the surfacing fabric by at least about 2, 3, 4, 5, 6, 7, 8, 9 times or more. Durability may be measured using methods known to those of skill in the art, such as, for example, ASTM D-638 Tensile Stress and Modulus, ASTM D-695 Compressive Stress and Modulus, ASTM D-790 Flexural Stress and Modulus, ASTM D-2344 Short Beam Shear, ASTM D-732 Punch Shear, ASTM D-256 Notched Izod Impact, ASTM D-2583 Barcol Hardness, ASTM D 570 24 Hour Water Absorption, ASTM D-792 Density, and/or ASTM D-696 Coefficient of Thermal Expansion.

In some embodiments, a surfacing fabric of the present invention may have increased abrasion resistance and/or may provide a composite of the present invention with increased abrasion resistance by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the abrasion resistance of a current commercial composite optionally comprising a paint and/or compared to the abrasion resistance of a composite without the surfacing fabric. In some embodiments, a surfacing fabric and/or composite of the present invention may provide an abrasion resistance that is greater than the abrasion resistance of a current commercial composite optionally comprising a paint and/or to the composite without the surfacing fabric by at least about 2, 3, 4, 5, 6, 7, 8, 9 times or more. Abrasion resistance may be measured using methods known to those of skill in the art, such as, for example, ASTM D 4060 Standard Test Method for Abrasion Resistance of Organic Coatings by the Taber Abraser.

In some embodiments, a surfacing fabric of the present invention may have increased surface appearance (e.g., increased gloss, increased smoothness, reduced roughness, etc.) and/or may provide a composite of the present invention with increased surface appearance by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the surface appearance of a current commercial composite optionally comprising a paint and/or compared to the surface appearance of a composite without the surfacing fabric. In some embodiments, a surfacing fabric and/or composite of the present invention may provide a surface appearance that is greater than the surface appearance of a current commercial composite optionally comprising a paint and/or to the composite without the surfacing fabric by at least about 2, 3, 4, 5, 6, 7, 8, 9 times or more. Surface appearance resistance may be measured using methods known to those of skill in the art, such as, for example, ASTM D523-14 Standard test method for Specular Gloss, ASTM D2565-99 (2008) Standard Practice for Xenon Arc Exposure of Plastics Intended for Outdoor Application, and/or JIS B 0601:2013 Geometrical Product Specifications (GPS)—Surface texture: Profile method. In some embodiments, surface appearance resistance refers to the surfacing fabric and/or composite maintaining or having a reduced amount of change in one or more surface appearance properties after a period of time and/or exposure to certain conditions (e.g., after accelerated UV exposure for 2000 hours, optionally as measured and/or performed in accordance with ASTM D2565) compared to the initial surface appearance property. The “initial surface appearance property” is the initial (i.e., original) surface appearance property upon formation of the surfacing fabric and/or composite (i.e., at time point 0). For example, in some embodiments, surface appearance resistance may refer to fade resistance at the surface with the appearance or color of the initial surface being compared to the amount of fading and/or color of the surface after a period of time and/or exposure to certain conditions.

In some embodiments, a surfacing fabric of the present invention may provide a composite of the present invention with an increased surface appearance by reducing the pattern print-through in the composite over a given amount of time as compared to a current commercial composite optionally comprising a paint and/or to a composite without the surfacing fabric. For example, a composite of the present invention may have no or minimal pattern print-through at 500, 1000, 1500, 2000, 2500, 3000 hours or more under certain conditions (e.g., accelerated UV exposure, optionally as measured and/or performed in accordance with ASTM D2565) compared to a current commercial composite optionally comprising a paint and/or to the composite without the surfacing fabric at the same time under similar or the same conditions. In some embodiments, a surfacing fabric of the present invention may have reduced fading and/or may provide a composite of the present invention with reduced fading after a given period of time by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the fading of a current commercial composite optionally comprising a paint and/or to a composite without the surfacing fabric after the same time under similar or the same conditions. In some embodiments, a surfacing fabric and/or composite of the present invention may exhibit no fading or fading that is less than the fading of a current commercial composite optionally comprising a paint and/or to the composite without the surfacing fabric by at least about 2, 3, 4, 5, 6, 7, 8, 9 times or more at a given amount of time (e.g., at 1000, 1500, 2000, 2500, or 3000 hours) under certain conditions (e.g., accelerated UV exposure, optionally as measured and/or performed in accordance with ASTM D2565). Fading may be measured using methods known to those of skill in the art, such as, for example, ASTM D2565-99(2008) Standard Practice for Xenon-Arc Exposure of Plastics Intended for Outdoor Applications, ASTM D1435-13 Standard Practice for Outdoor Weathering of Plastics, ASTM D4329-13 Standard Practice for Fluorescent Ultraviolet (UV) Lamp Apparatus Exposure of Plastics, and/or ASTM G 53 QUV Testing replaced by ASTM G154 Standard Practice for Operating Fluorescent Ultraviolet (UV) Lamp Apparatus for Exposure of Nonmetallic Materials.

In some embodiments, a surfacing fabric of the present invention may have reduced chalking and/or may provide a composite of the present invention with reduced chalking after a given period of time by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 350%, 400%, 450%, 500%, 550%, 600%, 650%, 700%, 750%, 800% or more compared to the chalking of a current commercial composite optionally comprising a paint and/or compared to the chalking of a composite without the surfacing fabric after the same time under similar or the same conditions. In some embodiments, a surfacing fabric and/or composite of the present invention may exhibit no chalking or chalking that is less than the chalking of a current commercial composite optionally comprising a paint and/or to the composite without the surfacing fabric by at least about 2, 3, 4, 5, 6, 7, 8, 9 times or more at a given amount of time (e.g., at 1000, 1500, 2000, 2500, or 3000 hours) under certain conditions (e.g., accelerated UV exposure, optionally as measured and/or performed in accordance with ASTM D2565). Chalking may be measured using methods known to those of skill in the art, such as, for example, ASTM D2565-99(2008) Standard Practice for Xenon-Arc Exposure of Plastics Intended for Outdoor Applications, ASTM D523-14 Standard Test Method for Specular Gloss, ASTM D1435-13 Standard Practice for Outdoor Weathering of Plastics, ASTM D4329-13 Standard Practice for Fluorescent Ultraviolet (UV) Lamp Apparatus Exposure of Plastics, and/or ASTM G 53 QUV Testing replaced by ASTM G154 Standard Practice for Operating Fluorescent Ultraviolet (UV) Lamp Apparatus for Exposure of Nonmetallic Materials.

In some embodiments, a surfacing fabric of the present invention may have a roughness and/or may provide a composite of the present invention with a roughness that is increased by no more than about 8, 9, 10, 15, 20, 25, 30, 35, 40, 45, 50, 55, 60, 65, 70, 75, 80, 85, 90, 95, 100, 110, 120, 130, or 140 microns after 2000 hours of UV exposure (e.g., accelerated UV exposure), such as, e.g., as measured and/or performed in accordance with ASTM D2565. Roughness may be measured using methods known to those of skill in the art, such as, but not limited to, by measuring the arithmetic height in microns from valley to peak using stylus profilometry.

In some embodiments, a surfacing fabric of the present invention may have a gloss reduction and/or may provide a composite of the present invention with a gloss reduction that is reduced by no more than about 40%, 45% or 50% after 2000 hours of UV exposure (e.g., accelerated UV exposure), such as, e.g., as measured and/or performed in accordance with ASTM D2565. Gloss reduction may be measured using methods known to those of skill in the art, such as, but not limited to, by measuring the percent of reflectance at a 60 degree angle.

In some embodiments, one or more improved properties of a surfacing fabric of the present invention and/or composite of the present invention (e.g., increased UV resistance and/or durability, increased surface appearance, reduced chalking, reduced roughness, etc.) may be measured or determined upon comparison of one or more initial properties of the surfacing fabric and/or composite to the one or more properties of the surfacing fabric and/or composite after a period of time (e.g., 1, 2, 3, 4, 5, 6, 7, 8, 9, 10, 11, or 12 day(s), week(s), months(s), or year(s)) and/or exposure to certain conditions, such as, e.g., after 1000, 1500, 2000, 2500, or 3000 hours of UV exposure (e.g., accelerated UV exposure), optionally as measured and/or performed in accordance with ASTM D2565. For example, reduced fading of a surfacing fabric of the present invention may be measured or determined by comparing the initial appearance or color of the surfacing fabric to the appearance or color of the surfacing fabric after a period of time and/or exposure to certain conditions.

A composite of the present invention may be used in any suitable industry and/or technology. Examples of where a composite of the present invention may be used include, but not limited to, boats, wind mill blades, window lineals, sheet piling, utility poles, tool handles, ladder rails, building cladding, cable trays, cooling towers, bridge decks, pipes, chemical containment vessels, structural parts, hand rails, and/or outdoor grating. In some embodiments, a composite of the present invention may be used in a composite part and/or structure that is exposed to environmental factors and/or is at risk for degradation due to UV, corrosion, and/or fire.

### EXAMPLES

### Example 1 (Sample 37)

Examples 2-4 provided below are permutations on the following processes for creating a composite part.

A surfacing fabric resin (SFR) was used to prepare a SFR composition, and the SFR composition was used to coat a fabric to form a surfacing fabric as described herein. The SFR composition for improving UV resistance was as follows:
Advalite™ vinyl hybrid resin Reichhold 4833-37: 100 Parts by Weight 93.37%
Syrgis 500-75P Initiator: 1.33 Parts by Weight 1.24%
Technick SR175-2 Mold Release: 0.75 Parts by Weight 0.70%
Chromaflo Black Pigment: CM20540 2 Parts by Weight 1.87%
UV Absorber: 2 Parts by Weight 1.87%
Hindered Amine Light Stabilizer: 1 Part by Weight 0.935%

Once heated, the SFR composition was mixed at medium shear for sufficient time to achieve a completely smooth, homogenous blend. Next, the SFR composition was heated to a liquefied state (appx. 145 degrees Fahrenheit) on hot plate and smoothly troweled onto 2 layers of PFG 60 gsm, non-apertured, solution-dyed, black spunlace fabric to form the surfacing fabric. The surfacing fabric was cooled to ambient condition providing the B-staged (i.e., partially cured) surfacing fabric. The surfacing fabric was cut to 14″×14″ pieces.

To create the remaining portion of the composite, the reinforcing material (that was covered by the surfacing fabric) was prepared using a commodity core resin (CCR) composition. The CCR composition was as follows:
DION® Thermosetting Polyester Resin Reichhold 31031 100 Parts by Weight 91.74%
Trigonox KSM C 75 1 Part by Weight 0.9174%
Technick SR 175-2 Mold Release 1 Part by Weight 0.9174%
ASP 400P Clay Filler 5 Parts by Weight 4.59%
Chromaflo Black Pigment CM 20540 2 Parts by Weight 1.835%

The CCR composition was mixed at medium shear for sufficient time to achieve a completely smooth homogenous resin.

To make the entire composite, five layers of 450 gram/sq. meter Continuous Filament Mat (CFM) were cut to 14″× 14″ and placed in a press mold. The CCR composition was poured on top of the CFM into the mold. The surfacing fabric was placed on top of the CCR/CFM layers in the press mold as the top layer. The mold press was programmed to mold the laminate of surface fabric onto the CFM with CCR into panels at 280 F 25 Tons of pressure for 10 minutes. The panels were removed from the press and cut to size for accelerated weathering testing.

This sample provided the best performing composite and is referred to herein as Sample 37.

### Example 2 (Traditional Veil)

Example 2 represents the control sample for comparison with other examples and is referred to herein as the Traditional Veil. It is similar to Example 1 except that the surfacing fabric is composed of standard PFG 37 gsm, apertured 111-90010 with no performance additives in the SFR composition or the CCR composition, and the commodity resin DION® FR 9350 was used in the surfacing fabric and the reinforcing material

### Example 3 (Sample 32)

Example 3 represents a sample that is relatively economical for comparison testing and is referred to herein as Sample 32. It is similar to Example 1 except the SFR in the SFR composition is DION® FR9350 and the SFR composition comprises black pigment and two UV resistant additives incorporated. The CCR in the CCR composition is DION® FR 9350 with one UV resistant additive incorporated.

### Example 4 (Painted Sample Composite)

For comparison purposes, a powder-coat painted composite was provided by a U.S. pultrusion company. The composite had no veil and the CCR was brominated resin similar to DION® FR 9350.

### Example 5

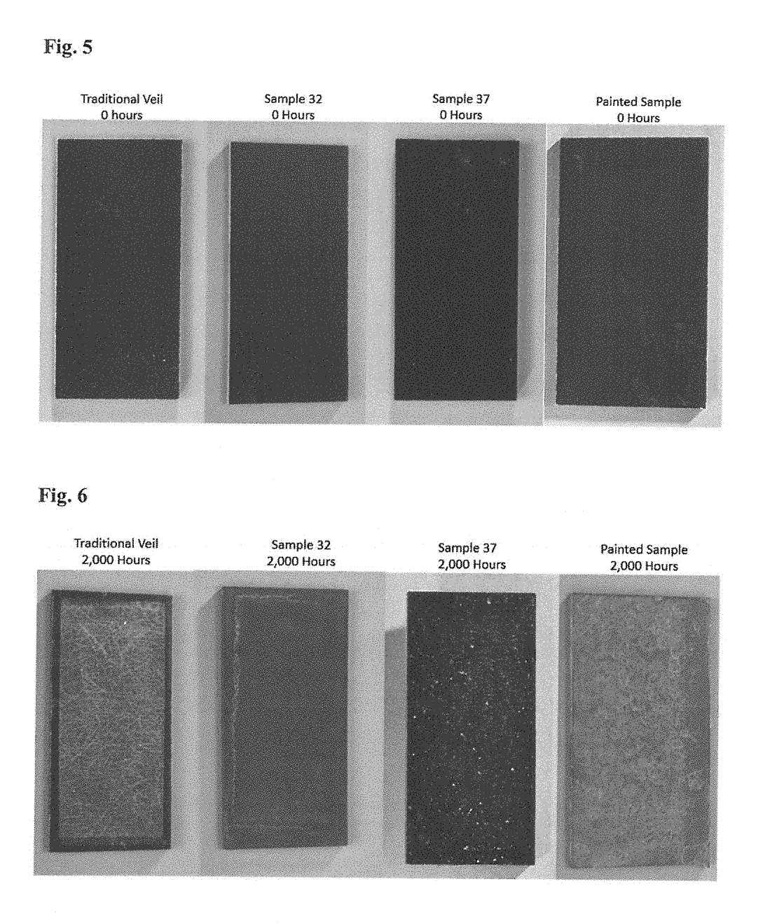

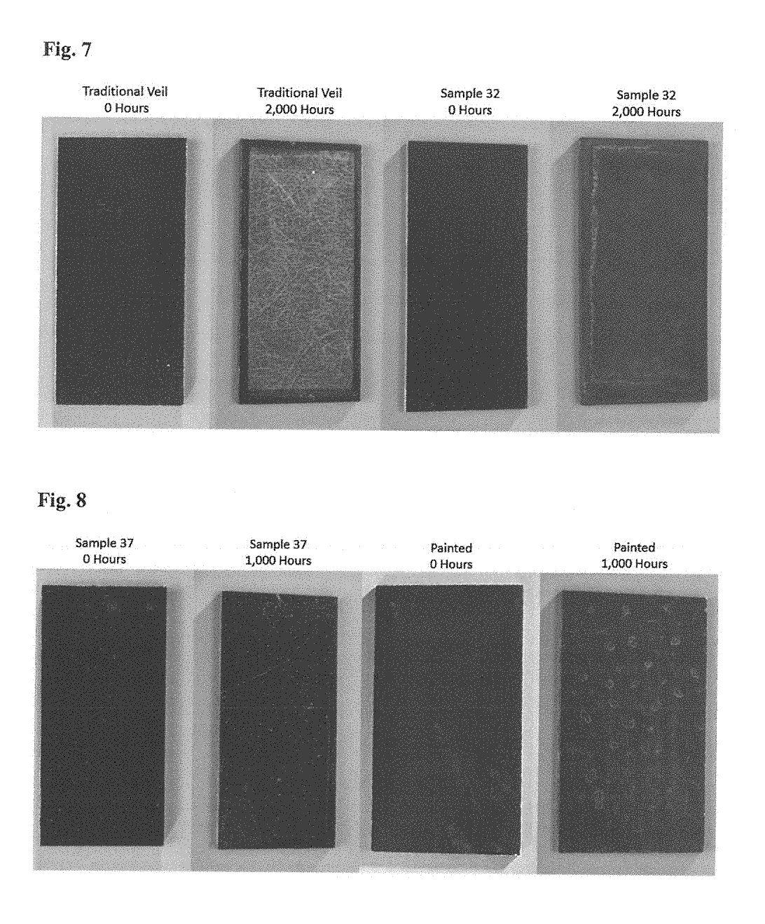

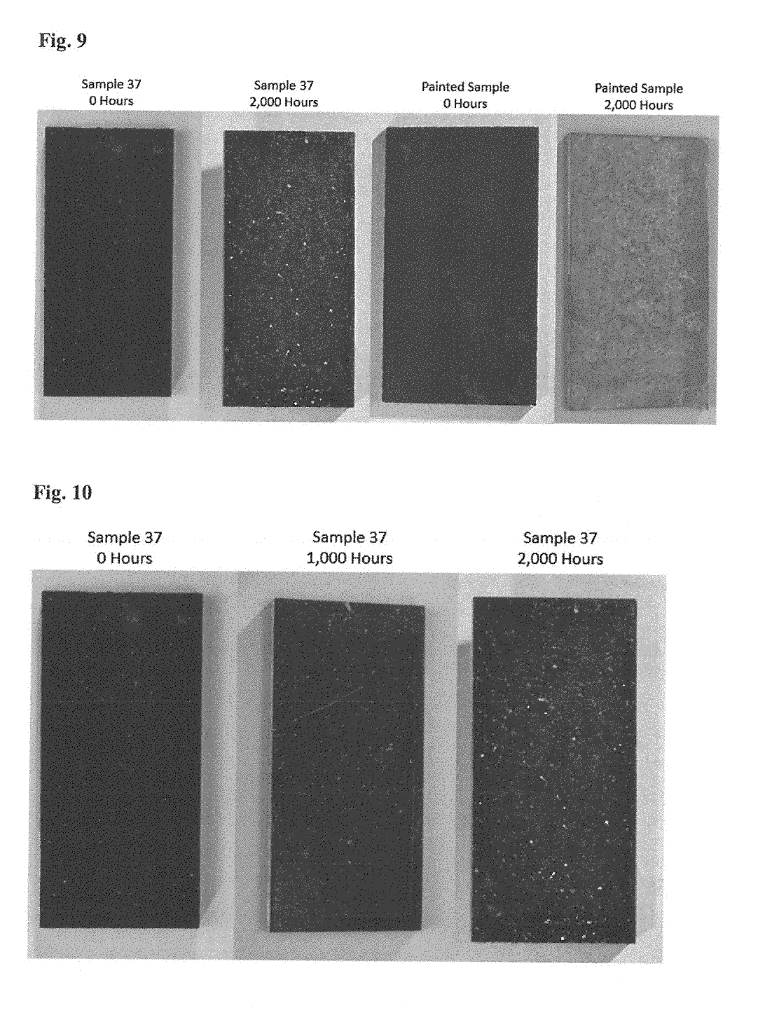

Photographs of the composites described in Examples 1-4 were taken. FIGS. 5 and 6 are photographs of each of the composites at 0 hours and 2,000 hours, respectively, of UV exposure. FIG. 7 is an image comparing the Traditional Veil Composite at 0 hours and 2,000 hours of UV exposure to the Sample 32 composite at 0 hours and 2,000 hours of UV exposure. FIG. 8 is an image comparing the Sample 37 composite at 0 hours and 1,000 hours of UV exposure to the Painted Sample composite at 0 hours and 1,000 hours of UV exposure. FIG. 9 is an image comparing the Sample 37 composite at 0 hours and 2,000 hours of UV exposure to the Painted Sample composite at 0 hours and 2,000 hours of UV exposure. FIG. 10 is an image comparing the Sample 37 composite at 0 hours, 1,000 hours and 2,000 hours of UV exposure. UV exposure was accelerated UV exposure in accordance with ASTM D2565.

Table 5 shows 60 degree gloss (% reflectance) and roughness (Ra—arithmetic height in microns from valley to peak using stylus profilometry) values for the various samples listed above. Table 6 compares the gloss loss and roughness after 2000 hours of UV exposure. Composite 37 performs similarly to the Painted sample in terms of roughness increase. Gloss was measured using Horiba IG-331 dual angle Gloss Checker. Surface roughness (Ra) was measured using Mitutoyo Surface Roughness Measuring Tester SJ-210 using Japanese Industrial Standards 1994.

TABLE 5
Gloss and Roughness Data
Gloss/Roughness Weathering Data

| | | Gloss | Ra |
|---|---|---|---|
| | | (%) | (microns) |
| FIG. 5 | Traditional Veil 0 hours | 25 | 95.6 |
| | Sample 32 0 hours | 36 | 89.1 |
| | Sample 37 0 hours | 75 | 10.9 |
| | Painted 0 hours | 17 | 69.5 |
| FIG. 6 | Traditional Veil 2000 hours | 0 | 229.3 |
| | Sample 32 2000 hours | 1 | 236.6 |
| | Sample 37 2000 hours | 30 | 18.3 |
| | Painted 2000 hours | 2 | 52.5 |
| FIG. 7 | Traditional Veil 2000 hours | 0 | 229.3 |
| | Sample 32 0 hours | 36 | 89.1 |
| | Sample 32 2000 hours | 1 | 236.6 |
| FIG. 8 | Sample 37 0 hours | 75 | 10.9 |
| | Sample 37 1000 hours | 57 | 15.5 |
| | Painted 0 hours | 17 | 69.5 |
| | Painted 1000 hours | 16 | 78.4 |
| FIG. 9 | Sample 37 0 hours | 75 | 10.9 |
| | Sample 37 2000 hours | 30 | 18.3 |
| | Painted 0 hours | 17 | 69.5 |
| | Painted 2000 hours | 2 | 52.5 |
| FIG. 10 | Sample 37 0 hours | 75 | 10.9 |
| | Sample 37 1000 hours | 57 | 15.5 |
| | Sample 37 2000 hours | 30 | 18.3 |

*Gloss measure at 60 degree angle
*Ra is the arithmetic mean distance of micropeaks and valleys in microns measured via surface profilometry. It approximates surface roughness.

TABLE 6
Summary of Gloss Reduction and Roughness Increase

| | | | |
|---|---|---|---|
| | Delta 0 to | Gloss | Ra |
| Summary | 2000 hours | Reduction | Increase |

| | | |
|---|---|---|
| Traditional Veil | −25 | 133.7 |
| Sample 32 | −35 | 147.5 |
| Sample 37 | −45 | 7.4 |
| Painted | −15 | 17 |

The foregoing is illustrative of the present invention, and is not to be cons-rued as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

1. A surfacing fabric comprising:
a fabric comprising at least one surface coated with a partially cured resin.

2. The surfacing fabric of claim 1, wherein the fabric comprises a nonwoven or woven fabric.

3. The surfacing fabric of claim 1, wherein the fabric is impregnated with the partially cured resin.

4. The surfacing fabric of claim 1, wherein the partially cured resin comprises at least one performance enhancing agent.

5.-9. (canceled)

10. The surfacing fabric of claim 1, further comprising a film and/or fabric on a surface of the surfacing fabric that opposes the surface of the surfacing fabric that faces the reinforcing material.

11. The surfacing fabric of claim 10, wherein the film and/or fabric is removable from the surfacing fabric.

12. The surfacing fabric of claim 1, further comprising an anti-migration layer adjacent to the fabric.

13. A composite comprising:
a surfacing fabric comprising at least one surface coated with a first resin;
a reinforcing material; and
a second resin, wherein the second resin binds the surfacing fabric to the reinforcing material, and
optionally wherein the second resin is different than the first resin.

14. The composite of claim 13, wherein the at least one surface of the surfacing fabric is an outer surface of the composite.

15. The composite of claim 13, wherein the first resin comprises at least one performance enhancing agent.

16. The composite of claim 13, wherein the surfacing fabric is impregnated with the first resin.

17. The composite of claim 13, wherein the second resin is a thermosetting resin.

18. The composite of claim 13, wherein the second resin impregnates the reinforcing material and optionally a portion of the surfacing fabric.

19.-24. (canceled)

25. The composite of claim 13, further comprising a film and/or fabric on a surface of the surfacing fabric that opposes the surface of the surfacing fabric that faces the reinforcing material.

26. The composite of claim 25, wherein the film and/or fabric is removable from the composite.

27. The composite of claim 13, further comprising an anti-migration layer between the surfacing fabric and the reinforcing material.

28.-40. (canceled)

41. A method of preparing a composite comprising:
placing a composite resin between a reinforcing material and a surfacing fabric comprising a surfacing resin; and
curing the composite resin, thereby preparing the composite.

42. The method of claim 41, wherein the composite resin binds the surfacing fabric to the reinforcing material.

43. The method of claim 41, wherein the surfacing fabric comprises at least one surface coated with the surfacing resin and the at least one surface of the surfacing fabric is an outer surface of the composite.

44.-53. (canceled)

54. The method of claim 41, further comprising placing an anti-migration layer between the surfacing fabric and the reinforcing material.
